(19) United States
(12) Patent Application Publication
(10) Pub. No.: US 2020/0404885 A1
(43) Pub. Date: Dec. 31, 2020

(54) ANIMAL TRAINING DEVICE

(71) Applicant: Vul-khane A Meroe, Covington, WA (US)

(72) Inventor: Vul-khane A Meroe, Covington, WA (US)

(21) Appl. No.: 16/452,501

(22) Filed: Jun. 25, 2019

(51) Int. Cl. A01K 15/02

(52) U.S. Cl. CPC A01K 15/021

(57) ABSTRACT

A soft foam ball is attached to a tether which is in turn attached to a handle having a motor. A switch activates the motor which provides a rotary output to swing the ball in a circle. A dog walker holds the handle and allows the ball to swing in front of the dog walker. If the dog ventures in front of the dog walker, the ball gently strikes the dog, reminding the dog of the proper heel position. The ball can be swung in either direction to allow a dog to heel on either side of a dog walker.

### BACKGROUND

When training an animal, such as a dog, oftentimes negative reinforcement is used to punish the bad behavior. In many cases, the negative reinforcement may be unpleasant or even painful for the animal. When training a dog to heel, for example, leash devices are used that may choke the dog or dig into the dog's neck as it pulls ahead of the owner. These types of devices, while sometimes effective, can cause serious harm to the animal.

Moreover, leash devices currently in use may further comprise a short attachment leash from the animal to the owner, such as attached to the thigh of an owner in an attempt to keep a dog close to the owner. In instances where a dog is excited and tries to leave the owner, a dog can cause harm to the owner, such as by pulling the owner to the ground.

What is needed is an improved device and method for training a dog to heel without the likelihood of causing harm to the animal or the owner.

### SUMMARY

According to some embodiments, an animal training system includes a handle having an internal power source, such as one or more batteries, and a motor. The motor has a rotary output shaft that is connected to a tether. Another end of the tether is coupled to a pendulum bob, which may be a ball. A switch mounted in the handle turns the motor on and off. The switch can reverse the polarity to the motor to drive the motor in either a clockwise or anti-clockwise rotary direction.

In some instances, the ball is formed of polyurethane foam, and may have portions formed of different materials and/or different densities. The switch in the handle may be a double-pole double-throw toggle switch.

The length of the tether (e.g., the distance of the tether between the rotary output shaft and the pendulum bob), may be adjustable to allow the ball to swing in a larger or smaller circle about the output shaft of the motor.

The rotary output shaft of the motor spins about an axis of rotation and may further have through hole formed therein transverse to the axis of rotation. In some instances, the tether passes through the through hole and can be selectively secured to affix the length of the tether between the rotary output shaft and the pendulum bob. In some cases, a set screw secures the position of the tether in the through hole to affix the length of the tether. Of course, other mechanisms can be used to adjust and secure the length of the tether.

According to some embodiments, a method of training a dog to heel includes providing a ball attached to a tether, selecting a length of the tether, and causing the ball to swing in a generally circular arc and substantially in a plane through which the dog should not penetrate. If the dog moves ahead of the dog walker, the ball may strike the dog if it penetrates the plane.

The dog walker may hold onto a handle having a motor inside the handle that spins the tether and the ball about the handle. The dog walker may hold the handle in front of herself and allow the ball to swing in a plane in front of the dog walker to define a plane through which the dog should not pass if the dog maintains an appropriate heel position relative to the dog walker.

The handle may have a switch that allows the motor to spin in either a clockwise or anti-clockwise direction. In some cases, the dog walker may attach a leash to the dog to encourage the dog to remain in a proper heel position. For instance, the dog may wear a collar or a harness and a leash can be attached to the collar or harness. The dog walker may hold the leash in one hand and vary the length of the leash to encourage the dog to stay in an appropriate heel position, which in some cases, is generally alongside the dog walker, or even slightly behind the dog walker.

The length of the tether can be adjusted to vary the radius of curvature of the swinging ball. In some instances, the radius of curvature is varied to ensure that the ball will contact the dog should the dog get in front of the dog walker.

According to some embodiments, a dog training apparatus includes a hollow handle having a motor inside the handle. The handle also holds batteries configured to power the motor. A tether is coupled to the motor and a ball is coupled to the tether. The length of the tether between the motor and the ball may be selectively adjustable, such as to ensure the ball contacts the dog should the dog venture in front of the dog walker.

The handle has a switch that can selectively deliver electricity to the motor to drive the motor in one or more directions. The ball may be formed with a core and an outer layer, and the core may have a higher density than the outer layer. In some cases, the ball is removable from the tether.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. A better understanding of the features, advantages and principles of the present disclosure will be obtained by reference to the following detailed description that sets forth illustrative embodiments, and the accompanying drawings, of which:

FIG. 1 depicts an animal training device in use according to some embodiments.

FIG. 2 illustrates an animal training device according to some embodiments.

FIG. 3, illustrates some components of an animal training device according to some embodiments.

FIG. 4 illustrates a sample electrical schematic diagram of an animal training device according to some embodiments.

FIG. 5 illustrates a sample attachment mechanism for a ball tether according to some embodiments.

While implementations are described herein by way of example, those skilled in the art will recognize that the implementations are not limited to the examples or drawings described. It should be understood that the drawings and detailed description thereto are not intended to limit implementations to the particular form disclosed but, on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

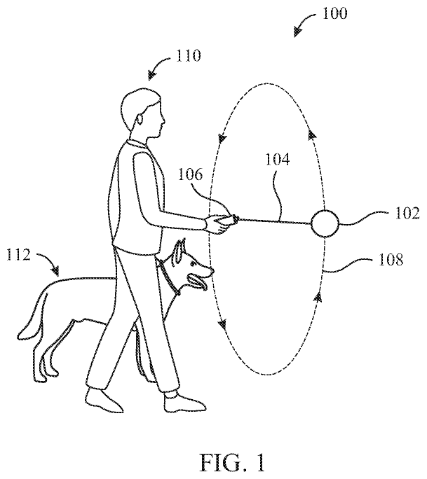

With reference to FIG. 1, an animal training device 100 is illustrated. According to some embodiments, a pendulum bob 102 is attached to one end of a tether 104. The tether 104, in turn, is attached to a handle 106. The handle 106 may include a motor for swinging the pendulum bob 102 in a generally circular arc 108. While the handle 106 is illustrated as a generally cylindrical configuration, other shapes are contemplated. For instance, the handle could be formed as a pistol-style grip or some other configuration.

In use, a dog walker 110 holds the handle and activates a motor in the handle 106, which causes the pendulum bob 102 to swing in an arc 108 about the motor. The length of the tether 104 may be variable and established so that the pendulum bob passes in front of the dog 112. If the dog 112 moves in front of the dog walker 110, the pendulum bob 102 may strike the dog 112 thereby providing an indication to the dog 112 that he has ventured into an area that has consequences, so the dog 112 is reminded to stay next to, or behind, the dog walker 110.

In some instances, the pendulum bob 102 is a ball, and will thus be referred to hereinafter as such, although one of ordinary skill in the art will recognize that any type of pendulum bob 102 is usable with the disclosed device. In some cases, the ball 102 is soft and made from a foamed material. For example, the ball may be formed of a solid, spongy cellular material, such as polyurethane. In other cases, the ball 102 may be formed from a closed cellular material. In some instances, the ball 102 may be inflatable. The ball 102 may be made of multiple materials. For example, the ball 102 may have a core formed of a relatively hard material, which is surrounded by a shell or an outer layer of a much softer material. In this instance, the core of the ball provides added weight to the ball to allow the ball to swing about the motor. Of course, other materials, shapes, and configurations are suitable to be used as a pendulum bob 102 that can swing on the tether 104 about the motor and not cause injury to an animal 112 if the pendulum bob 102 hits the animal.

While the ball 102 may be formed of any one or more of a number of materials, in some cases, it has sufficient weight to perform as a pendulum bob 102 to be swung in a circle by the motor.

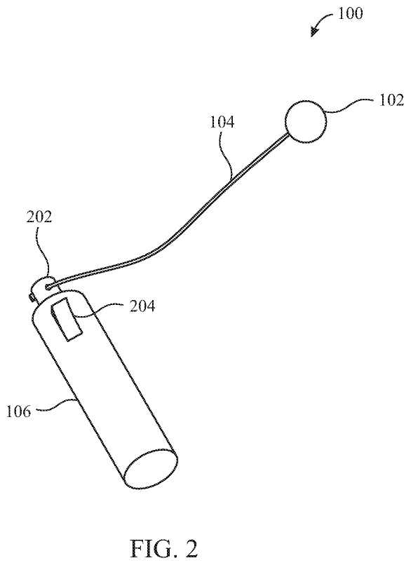

FIG. 2 illustrates an isometric view of an animal training device. The handle includes a motor. The motor includes an output 202 to which one end of the tether 104 is attached. The other end of the tether is attached to the ball 102.

The handle 106 may have a switch 204 for selectively operating the motor within the handle. In some cases, the switch is a two-position, or in some cases, a three-position switch. The switch may also be a double-pole double-throw (“DPDT”) switch and may allow the motor to operate in either a clockwise or anti-clockwise direction. For instance, where a dog walker 110 instructs a dog 112 to heel on the left side of the dog walker 110, as shown in FIG. 1, the motor may operate in an anti-clockwise direction (from the perspective of the dog walker 110) such that the ball swings downwardly toward the dog. Thus, if the dog 112 does not properly heel to the dog walker 110, the ball 102 may strike the dog 112 about the top of the nose, face, head, or back as an indication the dog 112 is in a space that is not consistent with a proper heel position.

Similarly, where the dog walker 110 instructs a dog 112 to heel on the right side of the dog walker, the motor may operate in a clockwise direction from the perspective of the dog walker 110 such that the ball 102 swings downwardly toward the dog 112.

The ball 102 may be secured to the tether 104 by any suitable mechanism. In some cases, the ball 102 is permanently affixed to the tether 104, while in other cases, the ball 102 may be removable from the tether 104, such as for replacing the ball 102 or exchanging it for a ball 102 having a different weight, density, size, hardness, or the like. The tether 104 may be formed of any suitable material. For example, the tether 104 may be synthetic or natural fiber string or twine, may be a monofilament or a multifilament structure, or any other suitable structure or material. In some embodiments, the tether is flexible while in other embodiments the tether is somewhat rigid. For example, the tether may have sufficient rigidity to maintain the ball 102 a fixed distance from the motor and may be formed of wire, plastic, or some other suitable material.

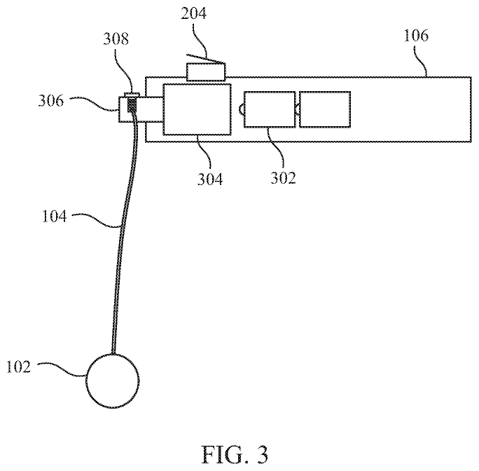

FIG. 3 is a schematic diagram showing some of the components of the animal training device. The handle includes a switch 204 in electrical connection with a power source, such as one or more batteries 302. The switch 204 is in further communication with the motor 304 to selectively provide energy from the battery 302 to the motor 304. The batteries may be any suitable batteries having any suitable battery chemistry, such as, for example, nickel cadmium, nickel-metal-hydride, lithium ion, lithium polymer, or any other such suitable battery. The batteries may also be rechargeable or disposable.

In some instances, the batteries are rechargeable, and a charging port and concomitant charging circuitry may be provided for receiving an input voltage and charging the rechargeable batteries within the handle.

The motor 304 may have an output shaft 306 that delivers a rotational output from the motor. The tether 104 is connected to the output shaft 306 by any suitable structure or method at or near an end of the tether 104. An opposing end of the tether 104 is coupled to the ball 102 as previously described.

In some instances, the length of the tether 104 between the output shaft 306 and the ball 102 is adjustable. For instance, different dog walkers 110 and different dogs 112 will have different heights. In order to maintain the ball 102 in a path that will intersect the dog 112, the tether 104 can be adjustable based upon the combination of dog walker 110 and dog 112. In some embodiments, the output shaft 306 may have a through hole therethrough along an axis that is transverse to the axis of rotation of the output shaft 306. The tether 104 may extend through the through hole and its length extending from the output shaft 306 to the ball 102 may be secured, such as by a set screw 308. The output shaft 306 may have a threaded hole that is transverse to, and intersects with, the through hole. As the position of the tether 104 is adjusted in the through hole to a desired length, the set screw 308 may be advanced in the threaded hole to secure the tether 104 at a desired length.

Of course, other mechanisms may be used for determining the length of the tether 104. For instance, a cam lock, a threaded coupler, a reel, or a clamp are all suitable mechanisms for determining the length of the tether 104.

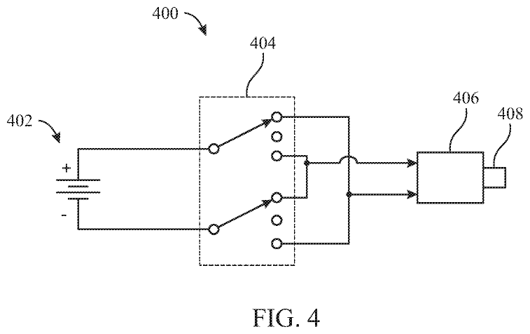

FIG. 4 is an electrical schematic of an electrical circuit 400 that is suitable for use with the described animal training device. In some instances, the electrical circuit 400 includes a power source 402, a switch 404, and a motor 406. The power source 402, which may be one or more batteries, is electrically connected to the switch 404. As illustrated, the switch may be a three-position switch, corresponding with clockwise, off, and anti-clockwise rotation of the output shaft 408 of the motor 406.

The switch 404 may be a rocker switch having two or three positions, and may be a toggle switch, or in some cases, may be a momentary switch. The switch 404 may also be a sliding switch corresponding with the described two or three positions.

The motor 406 may be any suitable motor, such as a DC motor that operates on any suitable voltage, such as 1.5V, 3V, 6V, 9V, 3.7V, 7.4V, 11.1V, 12V, 14.4V, 14.8V, 18V or some other suitable voltage provided by the power source 402 for driving the motor 406. The output shaft 408 of the motor 406 is configured for rotation about a rotational axis and may be driven at any suitable rotational speed, such as, for example, about 60 Rotations Per Minute (“RPM”), 120 RPM, 180 RPM, 220 RPM, or up to about 600 RPM, or some other desirable rotational speed. In some cases, the rotational speed of the motor is adjustable to account for different tether and ball combinations.

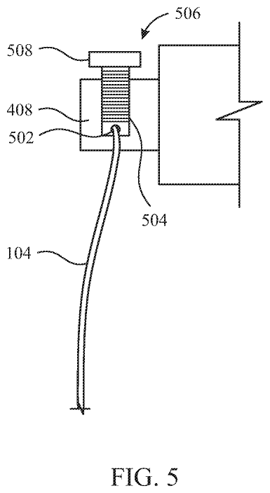

FIG. 5 is a view of the output shaft 408 of the motor and illustrates one embodiment of a securing mechanism that provides an adjustable length of the tether 104. A through hole 502 extends through the output shaft 408 and is sized to allow the tether 104 to slide therethrough. Transverse to the through hole 502 is a threaded hole 504 that accepts a set screw 506. The set screw 506 may have a knurled knob 508 to allow a user to twist the set screw 506 without requiring tools. In practice, a dog walker may feed the tether 104 through the through hole 502 and then advance the set screw 506 until the set screw secures the tether 104, such as by pinching the tether between the set screw and the bottom of the threaded hole 504. Of course, other methods of adjusting the length of the tether are possible and contemplated herein and this exemplary description should not be limiting of the scope.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventor contemplates the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. An animal training system, comprising:
a handle including an internal power source and a motor, the motor having a rotary output shaft;
a tether having a first portion attached to the rotary output shaft and a second end;
a pendulum bob connected to the second end of the tether; and
a switch mounted in the handle and electrically coupling the power source and the motor, the switch configured to provide power from the power source to the motor to drive the motor in one or more rotary directions.

2. The animal training system of claim 1, wherein the pendulum bob is a ball.

3. The animal training system of claim 2, wherein the ball is formed of polyurethane foam.

4. The animal training system of claim 1, wherein the switch is a double-pole double-throw toggle switch.

5. The animal training system of claim 1, wherein a length of the tether between the rotary output shaft and the pendulum bob is adjustable.

6. The animal training system of claim 5, wherein the rotary output shaft has an axis of rotation and further comprises a through hole formed transverse to the axis of rotation.

7. The animal training system of claim 6, wherein the tether extends through the through hole and is selectively secured to affix the length of the tether between the rotary output shaft and the pendulum bob.

8. The animal training system of claim 7, further comprising a screw that secures the position of the tether in the through hole.

9. A method of training a dog to heel, the method comprising the steps of:
providing a ball attached to a tether;
selecting a length of the tether; and
causing the ball to swing in a generally circular arc and substantially in a plane through which the dog should not penetrate, wherein the ball strikes the dog if the dog penetrates the plane.

10. The method of claim 9, wherein the step of providing the ball attached to the tether further comprises providing a handle coupled to the tether.

11. The method of claim 10, wherein providing a handle further comprises providing a handle comprising a motor.

12. The method of claim 11, further comprising the step of activating a switch to cause the motor to turn in one of a clockwise or anti-clockwise direction.

13. The method of claim 9, further comprising the step of coupling a leash to the dog and walking with the dog.

14. The method of claim 9, further comprising the step of adjusting the length of the tether.

15. A dog training apparatus, comprising:
a handle, the handle having a motor therein and one or more batteries configured to power the motor;
a tether coupled to the motor; and
a ball coupled to the tether.

16. The dog training apparatus of claim 15, wherein a length of the tether between the motor and the ball is selectively adjustable.

17. The dog training apparatus of claim 15, further comprising a switch configured to selectively deliver electricity to the motor.

18. The dog training apparatus of claim 17, wherein the switch is configured to deliver electricity to the motor to drive the motor in one or more directions.

19. The dog training apparatus of claim 15, wherein the ball has a core and an outer layer, the core having a higher density than the outer layer.

20. The dog training apparatus of claim 15, wherein the ball is removable from the tether.
